(19) United States
(12) Patent Application Publication
(10) Pub. No.: US 2025/0241308 A1
(43) Pub. Date: Jul. 31, 2025

(54) COMPOSITIONS AND METHODS FOR CONTROLLING PESTS

(71) Applicants: PYRONE SYSTEMS, INC., San Diego, CA (US); THE UNITED STATES OF AMERICA, AS REPRESENTED BY THE SECRETARY OF AGRICULTURE, Washington, DC (US)

(72) Inventors: Alexander Hutagalung, San Diego, CA (US); Joel Coats, San Diego, CA (US); Edmund Norris, San Diego, CA (US); Steve Bessette, San Diego, CA (US)

(21) Appl. No.: 19/071,197

(22) Filed: Mar. 5, 2025

Related U.S. Application Data
(63) Continuation of application No. PCT/US2023/032421, filed on Sep. 11, 2023.
(60) Provisional application No. 63/375,432, filed on Sep. 13, 2022.

(51) Int. Cl. A01N 43/16; A01M 1/20; A01P 7/04

(52) U.S. Cl. CPC A01N 43/16; A01M 1/20; A01P 7/04

(57) ABSTRACT

Embodiments of the present disclosure relate to compositions for controlling pests, the compositions including a pyrone in combination with a pyrethroid, a neonicotinoid, an organophosphate, and/or an enzyme inhibitor. Also provided herein are methods of making and using the compositions for controlling pests, such as insects, arachnids, and larvae.

### CROSS-REFERENCE TO RELATED APPLICATIONS

The present application is a continuation of PCT Patent Application No. PCT/US2023/032421, filed Sep. 11, 2023, which claims the benefit of priority of U.S. Provisional Application No. 63/375,432, filed Sep. 13, 2022, each of which is incorporated by reference in its entirety herein.

### FIELD

The present disclosure relates to compositions and methods of controlling pests. More particularly, the disclosure relates to compositions that include a pyrone, a pyrethroid, a neonicotinoid, an organophosphate, an enzyme inhibitor, or a combination thereof, and methods of making and using the compositions to control and/or kill pests, such as insects, arachnids, and larvae.

### BACKGROUND

Synthetic insecticides have been immensely important in combating mosquito populations throughout the world. Insecticide resistance has become progressively more widespread since first being scientifically recorded in 1914. Over 500 insect and mite species now show tolerance to pesticides, and pesticide resistance has become a serious threat to the future success of pest control. There are several definitions of insecticide resistance, and The World Health Organization has defined resistance as “the development of an ability in a strain of insects to tolerate doses of toxicant that would prove lethal to the majority of individuals in a normal population of the same species.”

### SUMMARY

The present disclosure generally relates to compositions that are formulated for use as a pesticide for killing, controlling, inhibiting, repelling, or mitigating pests, such as insects, arachnids, or larvae.

Accordingly, some embodiments provided herein relate to compositions that include at least one compound of Formula (I), in combination with at least one pesticide and/or at least one enzyme inhibitor. In some embodiments, the compound of the Formula (I) is:

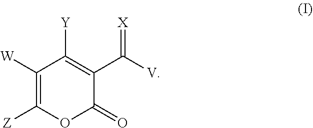

In some embodiments, V is a substituted or unsubstituted C₁-C₁₂ unbranched or branched alkyl, substituted or unsubstituted C₂-C₁₂ unbranched or branched alkenyl, substituted or unsubstituted C₃-C₁₂ unbranched or branched alkynyl, substituted or unsubstituted C₃-C₁₂ unbranched or branched cycloalkyl, substituted or unsubstituted heteroaryl, or a substituted or unsubstituted C₃-C₁₂ unbranched or branched cycloalkenyl. In some embodiments, W is a hydrogen or a substituted or unsubstituted C₃-C₆ saturated or unsaturated alkane or alkene. In some embodiments, X is an oxygen or a sulfur atom. In some embodiments, Y is a hydroxyl, sulphhydryl, amino, a halogen, or an ether with variable alkyl length (C₁-C₇). In some embodiments, Z is a substituted or unsubstituted C₁-C₁₂ unbranched or branched alkyl, substituted or unsubstituted C₃-C₁₂ unbranched or branched cycloalkyl, substituted or unsubstituted heteroaryl, or substituted or unsubstituted C₃-C₁₂ unbranched or branched cycloalkenyl. In some embodiments, W may be linked to Z via a substituted or unsubstituted C₃-C₆ saturated or unsaturated alkane or alkene.

In some embodiments, the at least one insecticide is a pyrethroid, a neonicotinoid, or an organophosphate. In some embodiments, the pyrethroid comprises allethrin, cyfluthrin, cyhalothrin, cypermethrin, deltamethrin, d-phenothrin, fenpropathrin, fenvalerate, flucythrinate, flumethrin, permethrin, phenothrin, resmethrin, sumithrin, tau-fluvalinate, tefluthrin, tetramethrin, or tralomethrin. In some embodiments, the neonicotinoid comprises Acetamiprid, Clothianidin, Imidacloprid, Nitenpyram, Thiacloprid, or Thiamethoxam. In some embodiments, the organophosphate comprises Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, or Vamidothion.

In some embodiments, the at least one enzyme inhibitor is a glutathione-S-transferase, a mixed function oxidase, or an esterase. In some embodiments, the glutathione-S-transferase inhibitor comprises diethyl maleate, quercetin, or tannic acid. In some embodiments, the mixed function oxidase comprises piperonyl butoxide, isoniazid, SKF 525A, or MGK 264. In some embodiments, the esterase comprises S,S,S-tributyl phosphorotrithioate, iprobenfos, triphenyl phosphate.

In some embodiments, the composition exhibits pesticidal, paralytic, repellent, or disruption of feeding and growth of invertebrates and/or larvae activities thereof without similarly affecting mammals, fish, or fowl. In some embodiments, the composition is formulated as a pesticide formulation. In some embodiments, the pesticide formulation is a wettable powder, granule, emulsifiable concentrate, spray, mist, solution, or ultra-low volume formulation to which water can be added to form an emulsion or a suspension. In some embodiments, the at least one compound of the Formula (I) can act as a synergist by significantly enhancing toxicity of the insecticide. In some embodiments, the at least one compound of the Formula (I) can be present in a sublethal dose. In some embodiments, the at least one compound of the Formula (I) comprises pogostone.

Some embodiments provided herein relate to methods of killing, controlling, paralyzing, repelling, knocking down, or disrupting a pest. In some embodiments, the methods include applying any of the compositions provided herein to a pest or to an environment in which a pest is to be controlled. In some embodiments, the pest is an insect, arachnid, or larvae thereof.

### BRIEF DESCRIPTION OF THE DRAWINGS

FIG. 1 depicts an assessment of pogostone applied topically to Aedes aegypti female mosquitoes to determine the sublethal dose for synergist experiments.

FIG. 2 depicts an assessment of the spatial repellency of pogostone on pyrethroid-susceptible (Orlando) and pyrethroid-resistant (Puerto Rico) strains of Aedes aegypti female adult mosquitoes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

Embodiments of the present disclosure relate to compositions used for controlling, killing, inhibiting, repelling, or mitigating pests. In particular, the disclosure relates to compositions that include a pyrone, a pyrethroid, a neonicotinoid, an organophosphate, an enzyme inhibitor, or a combination thereof. Some embodiments relate to methods of making the compositions. Some embodiments relate to methods of controlling, killing, inhibiting, repelling, or mitigating pests by applying the compositions described herein to an environment or region where pests are to be controlled.

By promoting the continued influx of sodium ions across the membrane of neurons in insects, pyrethroid insecticides cause hyper-excitability of the insect nervous system, contributing to spastic paralysis and inevitably death. Because pyrethroids readily migrate across the insect cuticle and diffuse evenly throughout the insect, they exert their toxic effects minutes after the target insect comes into contact with these compounds. One important symptom of pyrethroid intoxication is rapid immobilization (knockdown). Unlike some slow acting insecticides, pyrethroids are ideal for public health vector control because this knockdown effect prevents mosquitoes from feeding on future hosts. This property is also important for control of agricultural pests to prevent them from consuming any portion of the plant. Moreover, it likely contributes to the mortality of the intoxicated insect through numerous mechanisms, for example, desiccation, susceptibility to predation, and the inhibition of grooming which mitigates the accumulation of fungal spores on the insect. This knockdown effect is a crucial consideration in the development of future insecticidal formulations that contain natural products with novel modes of action.

One of the hurdles to identifying new insecticidal formulations is ensuring that these new mixtures will be fast-acting and cause high mortality while simultaneously being safe for application in residential areas, for example. Although many toxic synthetic insecticides exist which cause rapid nervous system intoxication, their high toxicity to humans and other vertebrates and relatively long half-lives in the environment prevents them from being viable avenues to follow in the search for new insecticidal formulations. It is paramount to identify candidate insecticides which have low mammalian toxicity, degrade rapidly, and still quickly immobilize and kill insects. Some compounds within plant essential oils possess these prerequisite characteristics (Isman 2011). To date, the understanding of plant essential oil mode of action is diverse and complex and suggests that several molecular targets are involved. For example, the potency of patchouli oil has been shown across a range of insects and its active component is likely a pyrone molecule that is different from the terpenoids present in plant essential oils (Chen 2017). In Drosophila melanogaster, the binding affinities of select terpenoids to a heterologously expressed tyramine receptor correlate directly with the toxicity of these terpenoids in the wild-type insect (Enan 2005). Also, significant specific binding of various terpenoids occurs at the Periplaneta americana octopamine receptor (Enan 2001). Plant essential oil components also exert their effects through other modes of action, for example by binding to GABAA receptor ion channel as antagonists, as acetylcholinesterase inhibitors, and as nicotinic acetylcholine receptor blockers (Tong and Coats 2010, Anderson and Coats 2012, Tong et al. 2012). Because of their diverse modes of action and the low likelihood of cross-resistance with current insecticides on the market, plant essential oils and their components may prove to be valuable tools in the pest management arsenal. Because of the rapid development of resistance to many of the currently available insecticides on the market, these plant essential oil components may be viable alternatives in future insecticidal formulations.

There are three major mechanisms by which resistance can occur: reduced penetration of the pest by the pesticide; metabolism of the insecticide (resulting in detoxification); and target-site insensitivity. These resistance mechanisms may exist individually in an insect, but are often found in combination where the overall resistance offered is substantially higher; this situation is referred to as ‘multi-factorial resistance’.

Many insects possess detoxification systems, which evolved originally to protect the insect from natural toxins in the environment. Metabolism of the insecticide may occur before it reaches its target-site when it comes into contact with those detoxifying enzymes that render it either less toxic or more easily excreted, or both. The most important enzyme systems involved in insecticide resistance include the groups a) mixed function oxidases, b) glutathione S-transferases and c) esterases. Resistance resulting from enhanced activity of one or more of these enzyme groups has been found in several insect species.

Insect detoxifying enzyme systems can be studied either in vivo by conventional bioassays, or in vitro by biochemical assays. In conventional bioassays, there is widespread employment of synergists such as DEF (S,S,S-tributyl phosphorothioate) and TPP (O,O,O-triphenyl phosphate). These are compounds that significantly enhance the toxicity of an insecticide, although they may be virtually non-toxic when used alone. Insecticide synergists act by inhibiting metabolic enzymes. Mortality differences in a bioassay, using a pesticide in the presence or absence of a synergist, should indicate whether a putative metabolic enzyme is involved in resistance.

Some embodiments provided herein relate to formulations containing a 2-pyrone molecule which include the compounds represented by the general Formula (I)

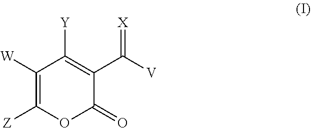

wherein V is a substituted or unsubstituted C₁-C₁₂ unbranched or branched alkyl, substituted or unsubstituted C₂-C₁₂ unbranched or branched alkenyl, substituted or unsubstituted C₃-C₁₂ unbranched or branched alkynyl, substituted or unsubstituted C₃-C₁₂ unbranched or branched cycloalkyl, substituted or unsubstituted heteroaryl, or a substituted or unsubstituted C₃-C₁₂ unbranched or branched cycloalkenyl; wherein W is a hydrogen or a substituted or unsubstituted C₃-C₆ saturated or unsaturated alkane or alkene; wherein X is an oxygen or a sulfur atom; wherein Y is hydroxyl, sulphhydryl, amino, a halogen, or an ether with variable alkyl length (C₁-C₇); wherein Z is a substituted or unsubstituted C₁-C₁₂ unbranched or branched alkyl, substituted or unsubstituted C₃-C₁₂ unbranched or branched cycloalkyl, substituted or unsubstituted heteroaryl, or substituted or unsubstituted C₃-C₁₂ unbranched or branched cycloalkenyl; and wherein W may be linked to Z via a substituted or unsubstituted C₃-C₆ saturated or unsaturated alkane or alkene.

In some embodiments, the compositions further include at least one insecticide and/or at least one enzyme inhibitor that may be referred to as a synergist. Some embodiments provided herein relate to methods of making the compositions. Some embodiments provide herein relate to methods of applying the compositions, wherein the compositions kill invertebrates, including, for example, insects, arachnids, and/or their larvae and has minimal effects on other species, such as mammals, fish, or fowl. In some embodiments, the compositions are applied at relatively low concentrations, which is effective over a comparatively long period of time such as at least 24 hours.

Unless defined otherwise, all technical and scientific terms used herein have the same meaning as is commonly understood by one of ordinary skill in the art. The use of the term “including” as well as other forms, such as “include”, “includes,” and “included,” is not limiting. The use of the term “having” as well as other forms, such as “have”, “has,” and “had,” is not limiting. As used in this specification, whether in a transitional phrase or in the body of the claim, the terms “comprise(s)” and “comprising” are to be interpreted as having an open-ended meaning. That is, the above terms are to be interpreted synonymously with the phrases “having at least” or “including at least.” For example, when used in the context of a process, the term “comprising” means that the process includes at least the recited steps, but may include additional steps. When used in the context of a compound, composition, or device, the term “comprising” means that the compound, composition, or device includes at least the recited features or components, but may also include additional features or components.

As used herein, any “R” group(s) represent substituents that can be attached to the indicated atom. R groups as described herein with respect to the pyrone compound (including the compound as set forth in Formula (I)), are defined with the symbols “V”, “W”, “X”, “Y”, and “Z”. The description of R groups applies to these groups defined in the compounds described herein. An R group may be substituted or unsubstituted. If two “R” groups are described as “together with the atoms to which they are attached” forming a ring or ring system, it means that the collective unit of the atoms, intervening bonds and the two R groups are the recited ring. For example,

It is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, CH₂CH(CH₃) CH₂—, and the like. Other radical naming conventions clearly indicate that the radical is a di-radical such as “alkylene” or “alkenylene.”

The term “halogen” or “halo,” as used herein, means any one of the radio-stable atoms of column 7 of the Periodic Table of the Elements, including, for example, fluorine, chlorine, bromine, or iodine.

As used herein, “Cₐ to C_{b}” in which “a” and “b” are integers refer to the number of carbon atoms in an alkyl, alkenyl or alkynyl group, or the number of ring atoms of a cycloalkyl or aryl group. That is, the alkyl, the alkenyl, the alkynyl, the ring of the cycloalkyl, and ring of the aryl can contain from “a” to “b”, inclusive, carbon atoms. For example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—; a C₃ to C₄ cycloalkyl group refers to all cycloalkyl groups having from 3 to 4 carbon atoms, that is, cyclopropyl and cyclobutyl. Similarly, a “4 to 6 membered heterocyclyl” group refers to all heterocyclyl groups with 4 to 6 total ring atoms, for example, azetidine, oxetane, oxazoline, pyrrolidine, piperidine, piperazine, morpholine, and the like. If no “a” and “b” are designated with regard to an alkyl, alkenyl, alkynyl, cycloalkyl, or aryl group, the broadest range described in these definitions is to be assumed. As used herein, the term “C₁-C₆” includes C₁, C₂, C₃, C₄, C₅ and C₆, and a range defined by any of the two numbers. For example, C₁-C₆ alkyl includes C₁, C₂, C₃, C₄, C₅ and C₆ alkyl, C₂-C₆ alkyl, C₁-C₃ alkyl, etc. Similarly, C₂-C₆ alkenyl includes C₂, C₃, C₄, C₅ and C₆ alkenyl, C₂-C₅ alkenyl, C₃-C₄ alkenyl, etc.; and C₂-C₆ alkynyl includes C₂, C₃, C₄, C₅ and C₆ alkynyl, C₂-C₅ alkynyl, C₃-C₄ alkynyl, etc. C₃-C₈ cycloalkyl each includes hydrocarbon ring containing 3, 4, 5, 6, 7 and 8 carbon atoms, or a range defined by any of the two numbers, such as C₃-C₇ cycloalkyl or C₅-C₆ cycloalkyl.

As used herein, “alkyl” refers to a straight or branched hydrocarbon chain that is fully saturated (i.e., contains no double or triple bonds). The alkyl group may have 1 to 20 carbon atoms (whenever it appears herein, a numerical range such as “1 to 20” refers to each integer in the given range; e.g., “1 to 20 carbon atoms” means that the alkyl group may consist of 1 carbon atom, 2 carbon atoms, 3 carbon atoms, etc., up to and including 20 carbon atoms, although the present definition also covers the occurrence of the term “alkyl” where no numerical range is designated). The alkyl group may also be a medium size alkyl having 1 to 9 carbon atoms. The alkyl group could also be a lower alkyl having 1 to 6 carbon atoms. The alkyl group may be designated as “C₁-C₄alkyl” or similar designations. By way of example only, “C₁-C₆ alkyl” indicates that there are one to six carbon atoms in the alkyl chain, i.e., the alkyl chain is selected from the group consisting of methyl, ethyl, propyl, iso-propyl, n-butyl, iso-butyl, sec-butyl, and t-butyl. Typical alkyl groups include, but are in no way limited to, methyl, ethyl, propyl, isopropyl, butyl, isobutyl, tertiary butyl, pentyl, hexyl, and the like.

As used herein, “alkoxy” refers to the formula-OR wherein R is an alkyl as is defined above, such as “C₁-C₉ alkoxy”, including but not limited to methoxy, ethoxy, n-propoxy, 1-methylethoxy (isopropoxy), n-butoxy, iso-butoxy, sec-butoxy, and tert-butoxy, and the like.

As used herein, “alkenyl” refers to a straight or branched hydrocarbon chain containing one or more double bonds. The alkenyl group may have 2 to 20 carbon atoms, although the present definition also covers the occurrence of the term “alkenyl” where no numerical range is designated. The alkenyl group may also be a medium size alkenyl having 2 to 9 carbon atoms. The alkenyl group could also be a lower alkenyl having 2 to 6 carbon atoms. The alkenyl group may be designated as “C₂-C₆ alkenyl” or similar designations. By way of example only, “C₂-C₆ alkenyl” indicates that there are two to six carbon atoms in the alkenyl chain, i.e., the alkenyl chain is selected from the group consisting of ethenyl, propen-1-yl, propen-2-yl, propen-3-yl, buten-1-yl, buten-2-yl, buten-3-yl, buten-4-yl, 1-methyl-propen-1-yl, 2-methyl-propen-1-yl, 1-ethyl-ethen-1-yl, 2-methyl-propen-3-yl, buta-1,3-dienyl, buta-1,2,-dienyl, and buta-1,2-dien-4-yl. Typical alkenyl groups include, but are in no way limited to, ethenyl, propenyl, butenyl, pentenyl, and hexenyl, and the like.

As used herein, “alkynyl” refers to a straight or branched hydrocarbon chain containing one or more triple bonds. The alkynyl group may have 2 to 20 carbon atoms, although the present definition also covers the occurrence of the term “alkynyl” where no numerical range is designated. The alkynyl group may also be a medium size alkynyl having 2 to 9 carbon atoms. The alkynyl group could also be a lower alkynyl having 2 to 6 carbon atoms. The alkynyl group may be designated as “C₂-C₆ alkynyl” or similar designations. By way of example only, “C₂-C₆ alkynyl” indicates that there are two to six carbon atoms in the alkynyl chain, i.e., the alkynyl chain is selected from the group consisting of ethynyl, propyn-1-yl, propyn-2-yl, butyn-1-yl, butyn-3-yl, butyn-4-yl, and 2-butynyl. Typical alkynyl groups include, but are in no way limited to, ethynyl, propynyl, butynyl, pentynyl, and hexynyl, and the like.

As used herein, “heteroalkyl” refers to a straight or branched hydrocarbon chain containing one or more heteroatoms, that is, an element other than carbon, including but not limited to, nitrogen, oxygen, and sulfur, in the chain backbone. The heteroalkyl group may have 1 to 20 carbon atoms, although the present definition also covers the occurrence of the term “heteroalkyl” where no numerical range is designated. The heteroalkyl group may also be a medium size heteroalkyl having 1 to 9 carbon atoms. The heteroalkyl group could also be a lower heteroalkyl having 1 to 6 carbon atoms. The heteroalkyl group may be designated as “C₁-C₆ heteroalkyl” or similar designations. The heteroalkyl group may contain one or more heteroatoms. By way of example only, “C₄-C₆ heteroalkyl” indicates that there are four to six carbon atoms in the heteroalkyl chain and additionally one or more heteroatoms in the backbone of the chain.

The term “aromatic” refers to a ring or ring system having a conjugated pi electron system and includes both carbocyclic aromatic (e.g., phenyl) and heterocyclic aromatic groups (e.g., pyridine). The term includes monocyclic or fused-ring polycyclic (i.e., rings which share adjacent pairs of atoms) groups provided that the entire ring system is aromatic.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms, although the present definition also covers the occurrence of the term “aryl” where no numerical range is designated. In some embodiments, the aryl group has 6 to 10 carbon atoms. The aryl group may be designated as “C₆-C₁₀ aryl,” “C₆ or C₁₀ aryl,” or similar designations. Examples of aryl groups include, but are not limited to, phenyl, naphthyl, azulenyl, and anthracenyl.

An “aralkyl” or “arylalkyl” is an aryl group connected, as a substituent, via an alkylene group, such as “C₇₋₁₄ aralkyl” and the like, including but not limited to benzyl, 2-phenylethyl, 3-phenylpropyl, and naphthylalkyl. In some cases, the alkylene group is a lower alkylene group (including, for example, a C₁-C₆ alkylene group).

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen, and sulfur, in the ring backbone. When the heteroaryl is a ring system, every ring in the system is aromatic. The heteroaryl group may have 5-18 ring members (for example, the number of atoms making up the ring backbone, including carbon atoms and heteroatoms), although the present definition also covers the occurrence of the term “heteroaryl” where no numerical range is designated. In some embodiments, the heteroaryl group has 5 to 10 ring members or 5 to 7 ring members. The heteroaryl group may be designated as “5-7 membered heteroaryl,” “5-10 membered heteroaryl,” or similar designations. Examples of heteroaryl rings include, but are not limited to, furyl, thienyl, phthalazinyl, pyrrolyl, oxazolyl, thiazolyl, imidazolyl, pyrazolyl, isoxazolyl, isothiazolyl, triazolyl, thiadiazolyl, pyridinyl, pyridazinyl, pyrimidinyl, pyrazinyl, triazinyl, quinolinyl, isoquinlinyl, benzimidazolyl, benzoxazolyl, benzothiazolyl, indolyl, isoindolyl, and benzothienyl.

A “heteroaralkyl” or “heteroarylalkyl” is heteroaryl group connected, as a substituent, via an alkylene group. Examples include but are not limited to 2-thienylmethyl, 3-thienylmethyl, furylmethyl, thienylethyl, pyrrolylalkyl, pyridylalkyl, isoxazollylalkyl, and imidazolylalkyl. In some cases, the alkylene group is a lower alkylene group (including, for example, a C₁-C₆ alkylene group).

As used herein, “carbocyclyl” means a non-aromatic cyclic ring or ring system containing only carbon atoms in the ring system backbone. When the carbocyclyl is a ring system, two or more rings may be joined together in a fused, bridged or spiro-connected fashion. Carbocyclyls may have any degree of saturation provided that at least one ring in a ring system is not aromatic. Thus, carbocyclyls include cycloalkyls, cycloalkenyls, and cycloalkynyls. The carbocyclyl group may have 3 to 20 carbon atoms, although the present definition also covers the occurrence of the term “carbocyclyl” where no numerical range is designated. The carbocyclyl group may also be a medium size carbocyclyl having 3 to 10 carbon atoms. The carbocyclyl group could also be a carbocyclyl having 3 to 6 carbon atoms. The carbocyclyl group may be designated as “C₃-C₆ carbocyclyl” or similar designations. Examples of carbocyclyl rings include, but are not limited to, cyclopropyl, cyclobutyl, cyclopentyl, cyclohexyl, cyclohexenyl, 2,3-dihydro-indene, bicycle[2.2.2]octanyl, adamantyl, and spiro[4.4]nonanyl.

As used herein, “cycloalkyl” means a fully saturated carbocyclyl ring or ring system. Examples include cyclopropyl, cyclobutyl, cyclopentyl, and cyclohexyl.

As used herein, “heterocyclyl” means a non-aromatic cyclic ring or ring system containing at least one heteroatom in the ring backbone. Heterocyclyls may be joined together in a fused, bridged or spiro-connected fashion. Heterocyclyls may have any degree of saturation provided that at least one ring in the ring system is not aromatic. The heteroatom(s) may be present in either a non-aromatic or aromatic ring in the ring system. The heterocyclyl group may have 3 to 20 ring members (i.e., the number of atoms making up the ring backbone, including carbon atoms and heteroatoms), although the present definition also covers the occurrence of the term “heterocyclyl” where no numerical range is designated. The heterocyclyl group may also be a medium size heterocyclyl having 3 to 10 ring members. The heterocyclyl group could also be a heterocyclyl having 3 to 6 ring members. The heterocyclyl group may be designated as “3-6 membered heterocyclyl” or similar designations. In preferred six membered monocyclic heterocyclyls, the heteroatom(s) are selected from one up to three of O, N or S, and in preferred five membered monocyclic heterocyclyls, the heteroatom(s) are selected from one or two heteroatoms selected from O, N, or S. Examples of heterocyclyl rings include, but are not limited to, azepinyl, acridinyl, carbazolyl, cinnolinyl, dioxolanyl, imidazolinyl, imidazolidinyl, morpholinyl, oxiranyl, oxepanyl, thiepanyl, piperidinyl, piperazinyl, dioxopiperazinyl, pyrrolidinyl, pyrrolidonyl, pyrrolidinonyl, 4-piperidonyl, pyrazolinyl, pyrazolidinyl, 1,3-dioxinyl, 1,3-dioxanyl, 1,4-dioxinyl, 1,4-dioxanyl, 1,3-oxathianyl, 1,4-oxathiinyl, 1,4-oxathianyl, 2H-1,2-oxazinyl, trioxanyl, hexahydro-1,3,5-triazinyl, 1,3-dioxolyl, 1,3-dioxolanyl, 1,3-dithiolyl, 1,3-dithiolanyl, isoxazolinyl, isoxazolidinyl, oxazolinyl, oxazolidinyl, oxazolidinonyl, thiazolinyl, thiazolidinyl, 1,3-oxathiolanyl, indolinyl, isoindolinyl, tetrahydrofuranyl, tetrahydropyranyl, tetrahydrothiophenyl, tetrahydrothiopyranyl, tetrahydro-1,4-thiazinyl, thiamorpholinyl, dihydrobenzofuranyl, benzimidazolidinyl, and tetrahydroquinoline.

An “O-carboxy” group refers to a “—OC(═O) R” group in which R is selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

A “C-carboxy” group refers to a “—C(═O)OR” group in which R is selected from the group consisting of hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein. A non-limiting example includes carboxyl (i.e., —C(═O)OH).

An “alkyl C-carboxy” group refers to an “—(CH)ₙC(═O)OR” group in which n is from 1 to 6 and the C(═O)OR group is the same as defined for a “C-carboxy” group.

A “thioalkyl” group refers to an “—SR” group in which R is selected from C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

A “sulfonyl” group refers to an “—SO₂R” group in which R is selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

A “sulfino” group refers to a “—S(═O)OH” group.

A “S-sulfonamido” group refers to a “—SO₂NR_{A}R_{B}” group in which R_{A} and R_{B} are each independently selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

An “N-sulfonamido” group refers to a “—N(R_{A})SO₂R_{B}” group in which R_{A} and R_{b} are each independently selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

A “C-amido” group refers to a “—C(═O)NR_{A}R_{B}” group in which R_{A} and R_{B} are each independently selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

An “N-amido” group refers to a “—N(R_{A}) C(═O) R_{B}” group in which R_{A} and R_{B} are each independently selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein.

An “amino” group refers to a “—NR_{A}R_{B}” group in which R_{A} and R_{B} are each independently selected from hydrogen, C₁-C₆ alkyl, C₂-C₆ alkenyl, C₂-C₆ alkynyl, C₃-C₇ carbocyclyl, C₆-C₁₀ aryl, 5-10 membered heteroaryl, and 3-10 membered heterocyclyl, as defined herein. A non-limiting example includes free amino (i.e., —NH₂).

An “aminoalkyl” group refers to an amino group connected via an alkylene group.

An “alkoxyalkyl” group refers to an alkoxy group connected via an alkylene group, such as a “C₂-C₈ alkoxyalkyl” and the like.

An “aralkoxy” or “arylalkoxy” is an aryl group connected, as a substituent, via an alkoxy group, such as “C₇₋₁₄ arylalkoxy” and the like, including but not limited to benzyl, 2-phenylethyl, 3-phenylpropyl, and naphthylalkyl. In some cases, the alkoxy group is a lower alkoxy group (i.e., a C₁-C₃ alkoxy group).

As used herein, a substituted group is derived from the unsubstituted parent group in which there has been an exchange of one or more hydrogen atoms for another atom or group. Unless otherwise indicated, when a group is deemed to be “substituted,” it is meant that the group is substituted with one or more substituents independently selected from C₁-C₆ alkyl, C₁-C₆ alkenyl, C₁-C₆ alkynyl, C₁-C₆ heteroalkyl, C₃-C₇ carbocyclyl (optionally substituted with halo, C₁-C₆ alkyl, C₁-C₆ alkoxy, C₁-C₆ haloalkyl, and C₁-C₆ haloalkoxy), C₃-C₇-carbocyclyl-C₁-C₆-alkyl (optionally substituted with halo, C₁-C₆ alkyl, C₁-C₆ alkoxy, C₁-C₆ haloalkyl, and C₁-C₆ haloalkoxy), 3-10 membered heterocyclyl (optionally substituted with halo, C₁-C₆ alkyl, C₁-C₆ alkoxy, C₁-C₆ haloalkyl, and C₁-C₆ haloalkoxy), 3-10 membered heterocyclyl-C₁-C₆-alkyl (optionally substituted with halo, C₁-C₆ alkyl, C₁-C₆ alkoxy, C₁-C₆ haloalkyl, and C₁-C₆ haloalkoxy), aryl (optionally substituted with halo, C₁-C₆ alkyl, C₁-C₆ alkoxy, C₁-C₆ haloalkyl, and C₁-C₆ haloalkoxy), aryl(C₁-C₆)alkyl (optionally substituted with halo, C₁-C₆ alkyl, C₁-C₆ alkoxy, C₁-C₆ haloalkyl, and C₁-C₆ haloalkoxy), 5-10 membered heteroaryl (optionally substituted with halo, C₁-C₆ alkyl, C₁-C₆ alkoxy, C₁-C₆ haloalkyl, and C₁-C₆ haloalkoxy), 5-10 membered heteroaryl(C₁-C₆)alkyl (optionally substituted with halo, C₁-C₆ alkyl, C₁-C₆ alkoxy, C₁-C₆ haloalkyl, and C₁-C₆ haloalkoxy), halo, —CN, hydroxy, C₁-C₆ alkoxy, C₁-C₆ alkoxy (C₁-C₆)alkyl (i.e., ether), aryloxy, sulfhydryl (mercapto), halo(C₁-C₆)alkyl (e.g., —CF₃), halo(C₁-C₆)alkoxy (e.g., —OCF₃), C₁-C₆ alkylthio, arylthio, amino, amino (C₁-C₆)alkyl, nitro, O-carbamyl, N-carbamyl, O-thiocarbamyl, N-thiocarbamyl, C-amido, N-amido, S-sulfonamido, N-sulfonamido, C-carboxy, O-carboxy, acyl, cyanato, isocyanato, thiocyanato, isothiocyanato, sulfinyl, sulfonyl, —SO₃H, sulfino, —OSO₂C₁₋₄alkyl, and oxo (═O). Wherever a group is described as “optionally substituted” that group can be substituted with the above substituents.

The term “hydroxy” as used herein refers to a —OH group.

The term “cyano” group as used herein refers to a “—CN” group.

The term “diazo” as used herein refers to a —N₂ group.

### Compositions

Some embodiments provided herein relate to compositions that are used for controlling a pest. In some embodiments, the compositions include a compound of Formula (I), in combination with at least one pesticide and/or at least one enzyme inhibitor. In some embodiments, the compounds of Formula (I) include

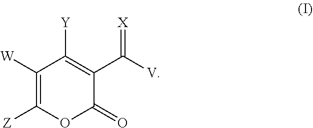

In some embodiments, V is a substituted or unsubstituted C₁-C₁₂ unbranched or branched alkyl, substituted or unsubstituted C₂-C₁₂ unbranched or branched alkenyl, substituted or unsubstituted C₃-C₁₂ unbranched or branched alkynyl, substituted or unsubstituted C₃-C₁₂ unbranched or branched cycloalkyl, substituted or unsubstituted heteroaryl, or a substituted or unsubstituted C₃-C₁₂ unbranched or branched cycloalkenyl. In some embodiments, W is a hydrogen or a substituted or unsubstituted C₃-C₆ saturated or unsaturated alkane or alkene. In some embodiments, X is an oxygen or a sulfur atom. In some embodiments, Y is a hydroxyl, sulphhydryl, amino, a halogen, or an ether with variable alkyl length (C₁-C₇). In some embodiments, Z is a substituted or unsubstituted C₁-C₁₂ unbranched or branched alkyl, substituted or unsubstituted C3-C12 unbranched or branched cycloalkyl, substituted or unsubstituted heteroaryl, or substituted or unsubstituted C3-C12 unbranched or branched cycloalkenyl. In some embodiments, W may be linked to Z via a substituted or unsubstituted C3-C6 saturated or unsaturated alkane or alkene.

In some embodiments, the at least one insecticide is a pyrethroid, a neonicotinoid, or an organophosphate. In some embodiments, the pyrethroid comprises allethrin, cyfluthrin, cyhalothrin, cypermethrin, deltamethrin, d-phenothrin, fenpropathrin, fenvalerate, flucythrinate, flumethrin, permethrin, phenothrin, resmethrin, sumithrin, tau-fluvalinate, tefluthrin, tetramethrin, or tralomethrin. In some embodiments, the neonicotinoid comprises Acetamiprid, Clothianidin, Dinotefuran, Imidacloprid, Nitenpyram, Thiacloprid, or Thiamethoxam. In some embodiments, the organophosphate comprises Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, or Vamidothion.

In some embodiments, the compound of Formula (I) is present in the compositions in an amount ranging from about 0.01 ng to about 1 mg per volume, such as 0.01, 0.1, 1, or 10 ng, 0.1, 1, or 10 μg, or 0.1 or 1 mg, or an amount within a range defined by any two of the aforementioned values, per volume, wherein the volume is an amount ranging from 0.1 mL to 1 L, such as 0.1, 1, 10, 100, or 1000 mL, or a volume within a range defined by any of the aforementioned values. In some embodiments, the insecticide is present in the compositions in an amount ranging from about 0.01 ng to about 1 mg per volume, such as 0.01, 0.1, 1, or 10 ng, 0.1, 1, or 10 μg, or 0.1 or 1 mg, or an amount within a range defined by any two of the aforementioned values, per volume, wherein the volume is an amount ranging from 0.1 mL to 1 L, such as 0.1, 1, 10, 100, or 1000 mL, or a volume within a range defined by any of the aforementioned values. In some embodiments, the enzyme inhibitor is present in the compositions in an amount ranging from about 0.01 ng to about 1 mg per volume, such as 0.01, 0.1, 1, or 10 ng, 0.1, 1, or 10 μg, or 0.1 or 1 mg, or an amount within a range defined by any two of the aforementioned values, per volume, wherein the volume is an amount ranging from 0.1 mL to 1 L, such as 0.1, 1, 10, 100, or 1000 mL, or a volume within a range defined by any of the aforementioned values. In some embodiments, any of the components of a compound of Formula (I), an insecticide, or an enzyme inhibitor is present in a solid formulation, wherein the amount of component is present in a mass per total mass (mass/mass), rather than mass/volume.

In some embodiments, the compositions are formulated as a pesticide formulation. In some embodiments, the formulation is a granule, a powder, a concentrate, a ready to use formulation, a spray, a solution, or an aerosol.

In some embodiments, a composition for controlling a pest is provided, wherein the composition includes pogostone and an insecticide. In some embodiments, a composition is provided including pogostone and a pyrethroid insecticide. In some embodiments, the pyrethroid insecticide can be permethrin. In some embodiments, a composition is provided including pogostone and a neonicotinoid insecticide. In some embodiments, the neonicotinoid insecticide can be dinotefuran. In some embodiments, pogostone can act as a synergist by significantly enhancing the toxicity of the insecticide. In some embodiments, enhanced toxicity can be determined by increased knockdown, and/or increased mortality. In some embodiments, pogostone can be present in a sublethal dose. In some embodiments, the composition including pogostone is equally effective at controlling pests that are susceptible or resistant to pyrethroid insecticides.

In some embodiments, a method for controlling a pest is provided, wherein the method includes applying a composition comprising pogostone and an insecticide. In some embodiments, a composition is provided including pogostone and a pyrethroid insecticide. In some embodiments, the pyrethroid insecticide can be permethrin. In some embodiments, a composition is provided including pogostone and a neonicotinoid insecticide. In some embodiments, the neonicotinoid insecticide can be dinotefuran. In some embodiments, pogostone can act as a synergist by significantly enhancing the toxicity of the insecticide. In some embodiments, enhanced toxicity can be determined by increased knockdown, and/or increased mortality. In some embodiments, pogostone can be present in a sublethal dose. In some embodiments, the composition including pogostone is equally effective at controlling pests that are susceptible or resistant to pyrethroid insecticides.

### Method of Making

Some embodiments provided herein relate to methods of making the compositions. In some embodiments, the methods include synthesizing the compounds of Formula (I), and adding the compounds of Formula (I) with one or more insecticide and/or with one or more enzyme inhibitor. In some embodiments, the composition is formulated such that a composition of the compound of Formula (I), a composition of an insecticide, and/or a composition of an enzyme inhibitor are stored separately, and are mixed just prior to application to a pest, or to an environment in which a pest is to be controlled. In some embodiments, the separate compositions are automatically mixed during or just prior to application. In some embodiments, a formulation is prepared having the separate compositions mixed together.

### Method of Controlling Pests

Some embodiments provided herein relate to methods of controlling pests. As used herein the term “controlling” has its ordinary meaning as understood in light of the specification, and refers to preventing, reducing, or eliminating the presence of a pest in an environment in which control of a pest is desired. In some embodiments, controlling pests includes killing, inhibiting, repelling, preventing, reducing, or eliminating the presence of a pest. In some embodiments, controlling pests includes disrupting activity of pests (such as feeding or mating), paralyzing pests, or otherwise preventing pests from thriving, spreading, living, or reproducing in an environment where control of pests is desired. In some embodiments, the methods include applying any of the compositions described herein to a pest, a colony of pests, or to an environment in which control of pests is desired. Application can be performed by spraying, misting, crop dusting, soaking, dripping, dropping, covering, sowing, directly positioning, or otherwise applying the compositions to a pest, colony of pests, or environment of interest. In some embodiments, the pest is an insect, an arachnid, or a larvae thereof.

Some embodiments provided herein are described in the following enumerated alternatives:
1. A composition, comprising: at least one compound of the Formula (I)

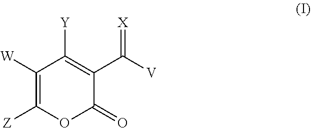

wherein V is a substituted or unsubstituted C₁-C₁₂ unbranched or branched alkyl, substituted or unsubstituted C₂-C₁₂ unbranched or branched alkenyl, substituted or unsubstituted C₃-C₁₂ unbranched or branched alkynyl, substituted or unsubstituted C₃-C₁₂ unbranched or branched cycloalkyl, substituted or unsubstituted heteroaryl, or a substituted or unsubstituted C₃-C₁₂ unbranched or branched cycloalkenyl; wherein W is a hydrogen or a substituted or unsubstituted C₃-C₆ saturated or unsaturated alkane or alkene; wherein X is an oxygen or a sulfur atom; wherein Y is a hydroxyl, sulphhydryl, amino, a halogen, or an ether with variable alkyl length (C₁-C₇); wherein Z is a substituted or unsubstituted C₁-C₁₂ unbranched or branched alkyl, substituted or unsubstituted C₃-C₁₂ unbranched or branched cycloalkyl, substituted or unsubstituted heteroaryl, or substituted or unsubstituted C₃-C₁₂ unbranched or branched cycloalkenyl; and wherein W may be linked to Z via a substituted or unsubstituted C₃-C₆ saturated or unsaturated alkane or alkene; and at least one insecticide and/or at least one enzyme inhibitor.
2. The composition of alternative 1, wherein the at least one insecticide is a pyrethroid, a neonicotinoid, or an organophosphate.
3. The composition of alternative 2, wherein the pyrethroid comprises allethrin, cyfluthrin, cyhalothrin, cypermethrin, deltamethrin, d-phenothrin, fenpropathrin, fenvalerate, flucythrinate, flumethrin, permethrin, phenothrin, resmethrin, sumithrin, tau-fluvalinate, tefluthrin, tetramethrin, or tralomethrin.
4. The composition of alternative 2, wherein the neonicotinoid comprises Acetamiprid, Clothianidin, Dinotefuran, Imidacloprid, Nitenpyram, Thiacloprid, or Thiamethoxam.
5. The composition of alternative 2, wherein the organophosphate comprises Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, or Vamidothion.
6. The composition of any one of alternatives 1-5, wherein the at least one enzyme inhibitor is a glutathione-S-transferase, a mixed function oxidase, or an esterase.
7. The composition of alternative 6, wherein the glutathione-S-transferase inhibitor comprises diethyl maleate, quercetin, or tannic acid.
8. The composition of alternative 6, wherein the mixed function oxidase comprises piperonyl butoxide, isoniazid, SKF 525A, or MGK 264.
9. The composition of alternative 6, wherein the esterase comprises S,S,S-tributyl phosphorotrithioate, iprobenfos, triphenyl phosphate.
10. The composition of any one of alternatives 1-9, wherein the composition exhibits pesticidal, paralytic, repellent, or disruption of feeding and growth of invertebrates and/or larvae activities thereof without similarly affecting mammals, fish, or fowl.
11. The composition of any one of alternatives 1-10, wherein the composition is formulated as a pesticide formulation.
12. The composition of alternative 11, wherein the pesticide formulation is a wettable powder, granule, emulsifiable concentrate, spray, mist, solution, aerosol, or ultra-low volume formulation to which water can be added to form an emulsion or a suspension.
13. The composition of any one of alternatives 1-12, wherein, the at least one compound of the Formula (I) acts as a synergist by significantly enhancing toxicity of the insecticide.
14. The composition of any one of alternatives 1-13, wherein the at least one compound of the Formula (I) is present in a sublethal dose.
15. The composition of any one of alternatives 1-14, wherein the at least one compound of the Formula (I) comprises pogostone.
16. A method for killing, controlling, paralyzing, repelling, knocking down, disrupting a pest, comprising applying any of the compositions described herein, including in of alternatives 1-15, to a pest or to an environment in which a pest is to be controlled.
17. The method of alternative 16, wherein the pest is an insect, arachnid, or larvae thereof.

### EXAMPLES

Some aspects of the embodiments discussed above are disclosed in further detail in the following examples, which are not in any way intended to limit the scope of the present disclosure. Those in the art will appreciate that many other embodiments also fall within the scope of the invention, as it is described herein above and in the claims.

### Example 1—Compositions

A pesticide composition is prepared that includes a compound of Formula (I) in combination with an insecticide and/or an enzyme inhibitor. Each component is present in an amount ranging from about 0.01 ng to about 1 mg per volume, such as 0.01, 0.1, 1, or 10 ng, 0.1, 1, or 10 μg, or 0.1 or 1 mg, or an amount within a range defined by any two of the aforementioned values, per volume, wherein the volume is an amount ranging from 0.1 mL to 1 L, such as 0.1, 1, 10, 100, or 1000 mL, or a volume within a range defined by any of the aforementioned values. The composition is formulated as a spray, mist, solution, concentrate, powder, granule, ready to use formulation, or aerosol.

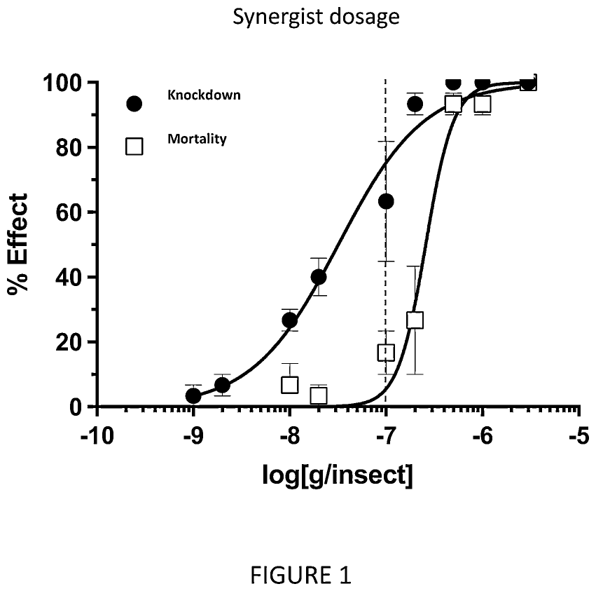

FIG. 1 shows the percentage 1-hour knockdown and 24-hour mortality of pogostone applied topically to Aedes aegypti female mosquitoes. The dashed line indicates sublethal dosage of pogostone used for synergist experiments in Example 2.

### Example 2—Methods of Controlling Pests

The following example demonstrates use of the compositions of Example 1 in controlling pests.

The compositions of Example 1 are applied directly to pests and/or to an environment where pests are to be controlled. The compositions control the pests by eradicating the pests from the environment, repelling pests from the environment, inhibiting pest growth and/or reproduction, paralyzing pests, reducing the presence of pests in the environment, disrupting pest feeding, social behavior, and/or reproduction, and/or killing pests where the compositions are applied.

Table 1 shows LD₅₀ values of insecticides applied alone and in combination with pogostone used at a sublethal dosage to Aedes aegypti adult female mosquitoes. Synergism ratios are presented as the ratio of the LD₅₀ of insecticide alone and the LD₅₀ of insecticide applied in combination with pogostone. The insecticidal effect of pogostone alone is corrected for using Abbott's formula (Equation 1) in all treatments using pogostone.

$$Corrected \% = ( 1 - {n}_{T} / {n}_{Co} ) \times 100 \qquad Equation 1$$

$$Where n = insect population ;$$

$$T = treated ;$$

$$Co = control$$

TABLE 1

| | | LD₅₀ | | Slope | Synergism |
|---|---|---|---|---|---|
| Treatment | N | (ng/mg) | 95% CI | (SEM) | Ratio |
| Permethrin | 190 | 0.37 | 0.29-0.0.45 | 2.4 (0.6) | 2.6* |
| +pogostone | 180 | 0.14 | 0.05-0.23 | 3.6 (1.1) | |
| Dinotefuran | 140 | 12.7 | 4-22 | 1.4 (0.4) | 6.0* |
| +pogostone | 140 | 2.1 | 1.1-3.1 | 1.1 (0.4) | |

Permethrin is representative of pyrethroid insecticides and dinotefuran is representative of neonicotinoid insecticides.

### Example 3

Topical applications of pogostone, DDT, veratrine, and natural pyrethrins (pyrethrum) were performed on pyrethroid-susceptible (Table 2) and pyrethroid-resistant strains (Table 3) of Aedes aegypti to determine KD₅₀ and LD₅₀ values for each compound.

KD₅₀=the dose required to knockdown half the members of a tested population after a specified test duration.

LD₅₀=the dose required to kill half the members of a tested population after a specified test duration.

TABLE 2
Aedes aegypti Orlando strain (pyrethroid-susceptible)

| | | KD₅₀, ng/mg | | Slope | LD₅₀, ng/mg | | Slope |
|---|---|---|---|---|---|---|---|
| Treatment | N | (95% CI) | | (SE) | (95% CI) | | (SE) |
| pogostone | 190 | 11 | (1-24) | 1.7 (0.4) | 96 | (60-133) | 3.4 (0.7) |
| DDT | 150 | 9.5 | (6.5-13) | 1.9 (0.3) | 9.6 | (7-12) | 3.1 (0.5) |
| veratrine | 150 | 270 | (210-330) | 4.7 (0.9) | 380 | (300-460) | 4.1 (0.8) |
| natural pyrethrins | 290 | 0.146 | (0.12-0.149) | 3.5 (0.8) | 1.5 | (1-3.3) | 1.5 (0.3) |

TABLE 3
Aedes aegypti Puerto Rican strain (pyrethroid-resistant)

| | | KD₅₀, ng/mg | | Slope | LD₅₀, ng/mg | | Slope |
|---|---|---|---|---|---|---|---|
| Treatment | N | (95% CI) | | (SE) | (95% CI) | | (SE) |
| pogostone | 130 | 14 | (2-36) | 1.8 (0.4) | 70 | (53-89) | 5.6 (1.6) |
| DDT | 180 | 350 | (26-520) | 1.9 (0.9) | 530 | (300-1130) | 1.4 (0.3) |
| veratrine | 150 | 142 | (58-227) | 2.2 (0.5) | 360 | (280-520) | 4.8 (1.0) |
| natural pyrethrins | 180 | 2 | (0.2-3) | 1.6 (0.7) | 20 | (12-24) | 2.6 (0.5) |

### Example 4

24-hour median lethal dose determinations of pogostone and permethrin were performed in three house fly strains and one stable fly strain. The KS17 resistant strain below is simultaneously resistant to organophosphates, carbamates, and synthetic pyrethroids.

TABLE 4

| Strain^{a} | Insecticide | N | LD₅₀ (95% CI)^{b} | | Slope | RR |
|---|---|---|---|---|---|---|
| CAR21 (S) | Pogostone | 640 | 7,600 | (5,340-10,430) | 4.6 | — |
| | Permethrin | 640 | 15.4 | (14.4-16.5) | 4.7 | — |
| WHF (R) | Pogostone | 760 | 13,900 | (12,480-15,380) | 2.7 | 1.8 |
| | Permethrin | 800 | 1,100 | (957-1260) | 1.6 | 71.5 |
| KS17 (R) | Pogostone | 600 | 10,700 | (9,550-11,900) | 3.1 | NS |
| | Permethrin | 800 | >5000 | | n/a | 325.1 |
| Stable flies (S) | Pogostone | 640 | 540 | (287-999) | 2.9 | — |
| | Permethrin | 640 | 1.81 | (1.59-2.12) | 2.2 | — |

^{a}(S) = insecticide susceptible, (R) = multi-insecticide resistant
^{b}Units of ng/fly
^{c}RR = resistance ratio, calculated as resistant strain LD₅₀ divided by susceptible strain LD₅₀ per insecticide. A value of ‘NS’ means not significantly different based on overlap of 95% confidence intervals (CIs).

### Example 5

48-hour median lethal dose determinations of pogostone and permethrin were performed in three house fly strains. The KS17 resistant strain below is simultaneously resistant to organophosphates, carbamates, and synthetic pyrethroids.

TABLE 5

| Strain^{a} | Insecticide | N | LD₅₀ (95% CI)^{b} | | Slope | RRc |
|---|---|---|---|---|---|---|
| CAR21 | Pogostone | 640 | 6,800 | (4,980-8,630) | 4.7 | — |
| (S) | Permethrin | 640 | 14.5 | (13.5-15.7) | 4.2 | — |
| WHF | Pogostone | 760 | 9,900 | (8,750-10,960) | 2.9 | 1.5 |
| (R) | Permethrin | 400 | 894 | (728-1,078) | 1.7 | 61.7 |
| KS17 | Pogostone | 360 | 6,890 | (5,880-7,750) | 3.4 | NS |

| | | | | | |
|---|---|---|---|---|---|
| (R) | Permethrin | 800 | >5,000 | na | 344.8 |

^{a}(S) = insecticide susceptible, (R) = multi-insecticide resistant
^{b}Units of ng/fly
^{c}RR = resistance ratio, calculated as resistant strain LD₅₀ divided by susceptible strain LD₅₀ per insecticide. A value of ‘NS’ means not significantly different based on overlap of 95% confidence intervals (CIs).

### Example 6

Spatial repellency of pogostone was assessed on pyrethroid-susceptible (Orlando) and pyrethroid-resistant (Puerto Rico) strains of Aedes aegypti female adult mosquitoes. Repellency bioassays were performed using a static air repellency chamber, which has been described previously (Schultz, 2006; Peterson, 2018). Briefly, the repellency chamber consists of a clear glass cylinder 600 mm in length with an inner diameter of roughly 85 mm laying horizontally. One end of the cylinder is capped with an untreated 90-mm filter paper (Whatman No. 1) contained in a 90-mm inner diameter glass petri dish, and sealed with tape to remain closed. The other end is capped in the same manner, except the filter paper has been treated with 1 mL of a 0.5% (w/v) solution of a monoterpenoid ester in acetone, resulting in 78.6 μg/cm² of repellent on the filter paper. The solution was added to the filter paper evenly and at a rate such that the evaporation of acetone prevents loss of compound from dripping, and the acetone was allowed to evaporate at room temperature for a further 10 minutes before use for the short-term repellency assay, or for an additional five hours under open air in ambient conditions in the case of long-term repellency studies. Shortly after placing the filter papers on the end of the tube, twenty (not blood fed) female Culex pipiens mosquitoes were anesthetized with carbon dioxide, and placed into the tube via a 20-mm hole halfway down the length of the tube, and the hole was sealed. This process is performed with as little disturbance to the air in the tube as possible. The distribution of mosquitoes between the treated and untreated sides was then noted at 15, 30, 60, 90, 120, and 150 minutes after placement into the tube. Repellency ratio of Orlando or Puerto Rico mosquitoes was recorded as a proportion of the number of mosquitoes on the treated side of the tube compared to the whole tube [number of treated side/total number throughout entire tube] at 1 hour after introducing the treated filter papers.

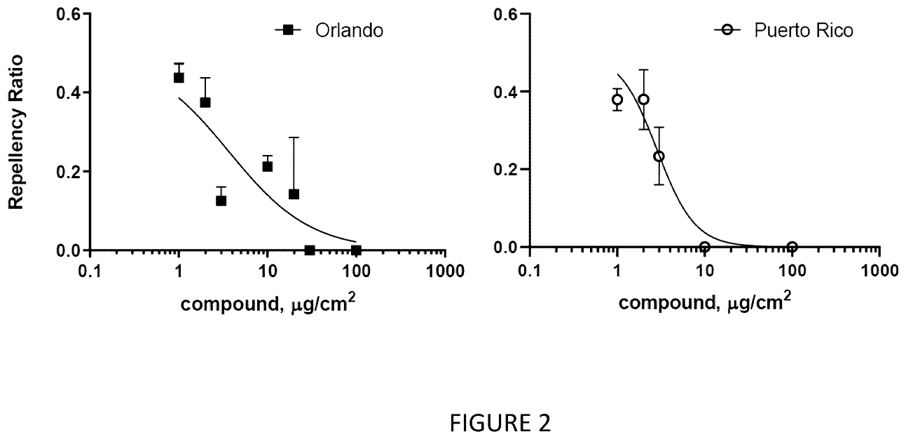

As shown in FIG. 2, pogostone was considerably repellent in this experimental assay on both strains. The EC₅₀ for the Orlando strain was 3.6 μg/cm² and 2.5 μg/cm² for the Puerto Rico strain. There was no statistically significant difference in the response of pogostone for these two strains. For reference, the EC₅₀ for DEET is approximately 10 μg/cm² on the Orlando strain.

Headings are included herein for reference and to aid in locating various sections. These headings are not intended to limit the scope of the concepts described with respect thereto. Such concepts may have applicability throughout the entire specification.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Their citation is not an indication of a search for relevant disclosures. All statements regarding the date(s) or contents of the documents is based on available information and is not an admission as to their accuracy or correctness.

In the foregoing description, specific details are given to provide a thorough understanding of the examples. However, it will be understood by one of ordinary skill in the art that the examples may be practiced without these specific details.

In at least some of the described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural or singular terms herein, those having skill in the art can translate from the plural to the singular or from the singular to the plural as is appropriate to the context or application. The various singular/plural permutations may be expressly set forth herein for sake of clarity.

The embodiments illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter, and use of the term “about” at the beginning of a string of values modifies each of the values. For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of the embodiments.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While preferred embodiments described herein have been shown and described herein, it will be obvious to those skilled in the art that such embodiments are provided by way of example only. Numerous variations, changes, and substitutions will now occur to those skilled in the art without departing from the description. It should be understood that various alternatives to the embodiments described herein may be employed in practicing the embodiments. It is intended that the following claims define the scope of embodiments provided herein and that methods and structures within the scope of these claims and their equivalents be covered thereby.

What is claimed is:

1. A composition, comprising:
a. at least one compound of the Formula (I) 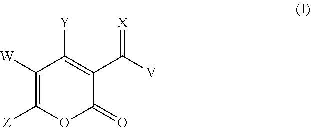
wherein V is a substituted or unsubstituted C₁-C₁₂ unbranched or branched alkyl, substituted or unsubstituted C₂-C₁₂ unbranched or branched alkenyl, substituted or unsubstituted C₃-C₁₂ unbranched or branched alkynyl, substituted or unsubstituted C₃-C₁₂ unbranched or branched cycloalkyl, substituted or unsubstituted heteroaryl, or a substituted or unsubstituted C₃-C₁₂ unbranched or branched cycloalkenyl;
wherein W is a hydrogen or a substituted or unsubstituted C₃-C₆ saturated or unsaturated alkane or alkene;
wherein X is an oxygen or a sulfur atom;
wherein Y is a hydroxyl, sulphhydryl, amino, a halogen, or an ether with variable alkyl length (C₁-C₇);
wherein Z is a substituted or unsubstituted C₁-C₁₂ unbranched or branched alkyl, substituted or unsubstituted C3-C12 unbranched or branched cycloalkyl, substituted or unsubstituted heteroaryl, or substituted or unsubstituted C3-C12 unbranched or branched cycloalkenyl; and
wherein W may be linked to Z via a substituted or unsubstituted C3-C6 saturated or unsaturated alkane or alkene; and
b. at least one insecticide and/or at least one enzyme inhibitor.

2. The composition of claim 1, wherein the at least one insecticide is a pyrethroid, a neonicotinoid, or an organophosphate.

3. The composition of claim 2, wherein the pyrethroid comprises allethrin, cyfluthrin, cyhalothrin, cypermethrin, deltamethrin, d-phenothrin, fenpropathrin, fenvalerate, flucythrinate, flumethrin, permethrin, phenothrin, resmethrin, sumithrin, tau-fluvalinate, tefluthrin, tetramethrin, or tralomethrin.

4. The composition of claim 2, wherein the neonicotinoid comprises Acetamiprid, Clothianidin, Dinotefuran, Imidacloprid, Nitenpyram, Thiacloprid, or Thiamethoxam.

5. The composition of claim 2, wherein the organophosphate comprises Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, or Vamidothion.

6. The composition of claim 1, wherein the at least one enzyme inhibitor is a glutathione-S-transferase, a mixed function oxidase, or an esterase.

7. The composition of claim 6, wherein the glutathione-S-transferase inhibitor comprises diethyl maleate, quercetin, or tannic acid.

8. The composition of claim 6, wherein the mixed function oxidase comprises piperonyl butoxide, isoniazid, SKF 525A, or MGK 264.

9. The composition of claim 6, wherein the esterase comprises S,S,S-tributyl phosphorotrithioate, iprobenfos, triphenyl phosphate.

10. The composition of claim 1, wherein the composition exhibits pesticidal, paralytic, repellent, or disruption of feeding and growth of invertebrates and/or larvae activities thereof without similarly affecting mammals, fish, or fowl.

11. The composition of claim 1, wherein the composition is formulated as a pesticide formulation.

12. The composition of claim 11, wherein the pesticide formulation is a wettable powder, granule, emulsifiable concentrate, spray, mist, solution, aerosol, or ultra-low volume formulation to which water can be added to form an emulsion or a suspension.

13. The composition of claim 1, wherein, the at least one compound of the Formula (I) acts as a synergist by significantly enhancing toxicity of the insecticide.

14. The composition of claim 1, wherein the at least one compound of the Formula (I) is present in a sublethal dose.

15. The composition of claim 1, wherein the at least one compound of the Formula (I) comprises pogostone.

16. A method for killing, controlling, paralyzing, repelling, knocking down, disrupting a pest, comprising: applying the composition of claim 1 to a pest or to an environment in which a pest is to be controlled.

17. The method of claim 16, wherein the pest is an insect, arachnid, or larvae thereof.
